(19) United States
(12) Patent Application Publication
(10) Pub. No.: US 2019/0177828 A1
(43) Pub. Date: Jun. 13, 2019

(54) THERMAL SPRAY COATING

(71) Applicants: Rolls-Royce Corporation, Indianapolis, IN (US); Rolls-Royce plc, London (GB)

(72) Inventors: Jun Shi, Carmel, IN (US); Roy Peter McIntyre, Derby (GB); Edward Sun, Brookline, MA (US)

(21) Appl. No.: 16/217,961

(22) Filed: Dec. 12, 2018

Related U.S. Application Data
(60) Provisional application No. 62/598,087, filed on Dec. 13, 2017.

(51) Int. Cl. C23C 4/134; G01B 7/16; G01B 11/16; G01L 5/00

(52) U.S. Cl. CPC C23C 4/134; G01L 5/00; G01B 11/16; G01B 7/18

(57) ABSTRACT

Example systems and techniques for controlling thermal spray processes and for determining properties of thermal spray coatings. A computing device may control a thermal spray gun to thermally spray a substrate in a thermal spray cycle including a plurality of passes of a coating material to form a coating. The computing device may determine a change in curvature of the substrate during the thermal spraying, and determine properties of the coating based on the changes in the curvature. The computing device may control the thermal spray gun based on the determined properties.

This application claims the benefit of U.S. Provisional Application No. 62/598,087, filed Dec. 13, 2017, which is incorporated herein by reference in its entirety.

### TECHNICAL FIELD

The present disclosure generally relates to thermal spray coating.

### BACKGROUND

Thermal spray systems are used in a wide variety of industrial applications to coat substrates with coating material to modify or improve the properties of the target surface. Coatings may include thermal barrier coatings, wear coatings, ablative coatings, or the like. Thermal spray systems use heat generated electrically, by plasma, or by combustion to heat material injected in a plume, so that softened or molten material propelled by the plume contacts the surface of the target. Upon impact, the material adheres to the target surface, resulting in a coating. The properties of coatings applied on substrates by thermal spraying may depend on the parameters used for controlling the thermal spraying.

### SUMMARY

In some examples, the disclosure describes an example technique for thermal spraying. The example technique includes thermally spraying a substrate in a thermal spray cycle. The thermal spray cycle includes a plurality of passes of a coating material to form a coating. The example technique includes determining, by a computing device, a change in curvature of the substrate Δκ during a central pass of the plurality of passes. The example technique includes determining, by the computing device, residual stress σ of the coating based on the change in the curvature ΔK.

In some examples, the disclosure describes an example system including a thermal spray gun and a computing device. The computing device is configured to control the thermal spray gun to thermally spray a substrate in a thermal spray cycle. The thermal spray cycle includes a plurality of passes of a coating material to form a coating. The computing device is configured to determine a change in curvature of the substrate Δκ during a central pass of the plurality of passes. The computing device is configured to determine residual stress σ of the coating based on the change in the curvature Δκ.

In some examples, the disclosure describes a computer readable storage medium comprising instructions. The instructions, when executed, cause at least one processor to control a thermal spray gun to thermally spray a substrate in a thermal spray cycle including a plurality of passes of a coating material to form a coating. The instructions, when executed, cause at least one processor to determine a change in curvature of the substrate Δκ during a central pass of the plurality of passes. The instructions, when executed, cause at least one processor to determine residual stress σ of the coating based on the change in the curvature Δκ.

In some examples, the disclosure describes an example technique for thermal spraying. The example technique includes thermally spraying a substrate in a thermal cycle. The thermal cycle includes a plurality of passes of a coating material to form a coating. The example technique includes receiving, by a computing device, a first signal indicative of changes in bending deflection of the substrate at a predetermined location along the substrate over a first coating cycle. The example technique includes receiving, by the computing device, a second signal indicative of changes in bending deflection of the substrate at the predetermined location along the substrate over a second coating cycle. The example technique includes determining, by the computing device, a first frequency spectrum of the bending deflection over the first coating cycle. The example technique includes determining, by the computing device, a first plurality of peaks of the first frequency spectrum. The example technique includes determining, by the computing device, a second frequency spectrum of the bending deflection over the second coating cycle. The example technique includes determining, by the computing device, and a second plurality of peaks of the second frequency spectrum. The example technique includes determining, by the computing device, a plurality of frequency shifts between respective peaks of the first plurality of peaks and corresponding peaks of the second plurality of peaks. The example technique includes determining, by the computing device, a modulus of the coating based on the plurality of shifts.

In some examples, the disclosure describes an example system including a thermal spray gun and a computing device. The computing device is configured to control the thermal spray gun to thermally spray a substrate in a thermal spray cycle. The thermal spray cycle includes a plurality of passes of a coating material to form a coating. The computing device is configured to control the thermal spray gun to thermally spray a substrate in a thermal cycle. The thermal cycle includes a plurality of passes of a coating material to form a coating. The computing device is configured to receive a first signal indicative of changes in bending deflection of the substrate at a predetermined location along the substrate over a first coating cycle. The computing device is configured to receive a second signal indicative of changes in bending deflection of the substrate at the predetermined location along the substrate over a second coating cycle. The computing device is configured to determine a first frequency spectrum of the bending deflection over the first coating cycle. The computing device is configured to determine a first plurality of peaks of the first frequency spectrum. The computing device is configured to determine a second frequency spectrum of the bending deflection over the second coating cycle. The computing device is configured to determine a second plurality of peaks of the second frequency spectrum. The computing device is configured to determine a plurality of frequency shifts between respective peaks of the first plurality of peaks and corresponding peaks of the second plurality of peaks. The computing device is configured to determine a modulus of the coating based on the plurality of shifts.

In some examples, the disclosure describes a computer readable storage medium comprising instructions. The instructions, when executed, cause at least one processor to control a thermal spray gun to thermally spray a substrate in a thermal spray cycle. The instructions, when executed, cause at least one processor to receive a first signal indicative of changes in bending deflection of the substrate at a predetermined location along the substrate over a first coating cycle. The instructions, when executed, cause at least one processor to receive a second signal indicative of changes in bending deflection of the substrate at the predetermined location along the substrate over a second coating cycle. The instructions, when executed, cause at least one processor to determine a first frequency spectrum of the bending deflection over the first coating cycle. The instructions, when executed, cause at least one processor to determine a first plurality of peaks of the first frequency spectrum.

The instructions, when executed, cause at least one processor to determine a second frequency spectrum of the bending deflection over the second coating cycle. The instructions, when executed, cause at least one processor to determine a second plurality of peaks of the second frequency spectrum. The instructions, when executed, cause at least one processor to determine a plurality of frequency shifts between respective peaks of the first plurality of peaks and corresponding peaks of the second plurality of peaks. The instructions, when executed, cause at least one processor to determine a modulus of the coating based on the plurality of shifts.

The details of one or more examples are set forth in the accompanying drawings and the description below. Other features, objects, and advantages will be apparent from the description and drawings, and from the claims.

### BRIEF DESCRIPTION OF DRAWINGS

FIG. 1A is a conceptual and schematic block diagram illustrating an example system for thermal spraying.

FIG. 1B is a conceptual and schematic block diagram illustrating an example thermal spray cycle of a coating applied to a substrate by the thermal spray system of FIG. 1A.

FIG. 2 is a schematic chart illustrating temperature of substrate 14 as a function of time for multiple thermal spray cycles during an example thermal spray process.

FIG. 3 is a schematic chart illustrating thermal spray passes and cycles during an example thermal spray process.

FIG. 4A is a schematic chart illustrating temporal changes in bending deflection of a substrate during a thermal spray process.

FIG. 4B is a schematic chart illustrating peak shifts in frequency spectra of bending deflections during a thermal spray process.

FIG. 5 is a flow diagram illustrating an example technique for thermal spraying.

FIG. 6 is a flow diagram illustrating an example technique for thermal spraying.

### DETAILED DESCRIPTION

The disclosure describes example systems and techniques for thermal spraying coatings on substrates. In some examples, properties of coatings may be determined based on bending deflections exhibited by substrate in response to the thermal spraying. For example, example techniques and systems according to the disclosure may be used to determine coating residual stress or coating modulus, for example, Young's modulus, and to control the thermal spraying based on the properties of the coatings. Such properties of coatings may relate to durability and other functional performance of thermally sprayed coatings.

In some examples, substrate deformation, for example, bending deflection or changes in curvature may be measured at different time intervals during the thermal spraying. Based on relationships between curvature and residual stress, or by evaluating finite element models, properties of coatings can be ultimately determined based on the substrate deformations. For example, change in curvature after the coating and substrate has reached a steady state may be used to determine residual stress in coatings, so that the curvature is substantially a result of quench stress, rather than of thermal gradients between a coating and a substrate. In some examples, such as when the coating is thin or when the substrate is stiff, the coating and the substrate may not reach a thermal steady state, or the change in curvature may be relatively small. The small change in curvature may reduce the accuracy of determining coating properties based on curvature changes. Further, if multiple layers of coating material are sprayed, prior layers may not cool down completely before subsequent layers are sprayed, leading to errors in determining coating properties.

In some examples in accordance with this disclosure, curvature determined during a mid-point of a thermal cycle may be used to increase the measured change in curvature, and increase the accuracy of determining coating properties. In other examples, finite element models may be iterated through different intervals of the thermal cycle, and shifts in frequency spectra of bending deflections or vibrations may be used to determine coating properties with increased accuracy.

Further, example techniques and systems according to the disclosure may be used to control thermal spraying based on the determined properties of the coating, for example, to prepare coatings meeting predetermined specifications.

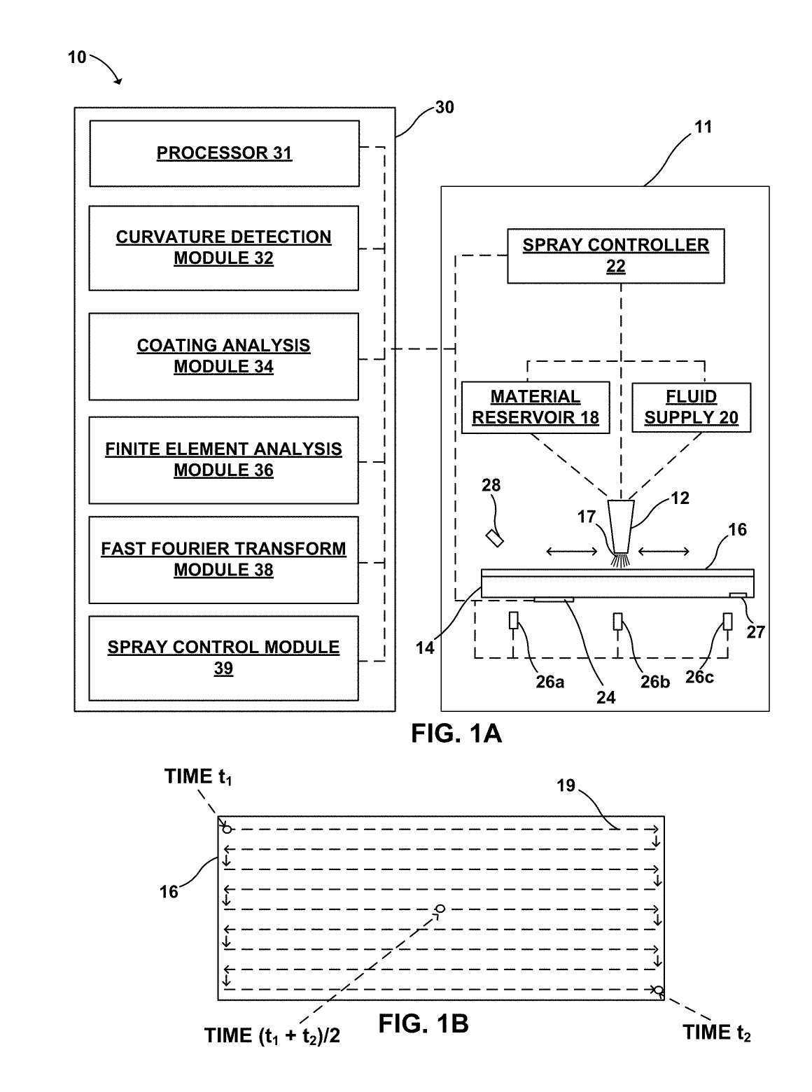

FIG. 1A is a conceptual and schematic block diagram illustrating an example system 10 for thermal spraying. In some examples, thermal spray system 10 includes components such as an enclosure 11, a thermal spray gun 12, a substrate 14, and a computing device 30.

Enclosure 11 encloses some components of thermal spray system 10, including, for example, thermal spray gun 12 and substrate 14. In some examples, enclosure 11 substantially completely surrounds thermal spray gun 12 and substrate 14 and encloses an atmosphere. The atmosphere may include, for example, air, an inert atmosphere, a vacuum, or the like. In some examples, the atmosphere may be selected based on the type (e.g., composition) of coating being applied using thermal spray system 10, the composition of substrate 14, or both.

Substrate 14 is coated with a coating 16 using thermal spray system 10. In some examples, substrate 14 may include, for example, a substrate on which a bond coat, a primer coat, a hard coat, a wear-resistant coating, a thermal barrier coating, an environmental barrier coating, an abrasive coating, an abradable coating, or the like is to be deposited. Substrate 14 may include a body of any regular or irregular shape, geometry or configuration. In some examples, substrate 14 includes a substantially rectangular parallelepiped component, for example, a sheet, a block, or a rod with rectangular cross-section. In some examples, substrate 14 may include metal, plastic, glass, or the like. Substrate 14 may be a component used in any one or more mechanical systems, including, for example, a high temperature mechanical system such as a gas turbine engine. In some examples, substrate 14 may include a test coupon or test sample used to test performance of thermal spray system 10.

Thermal spray gun 12 is coupled to a material reservoir 18 via material inlet port (not shown) and to a fluid supply 20 via a fluid inlet port (not shown). Thermal spray gun 12 is also coupled to, or includes, an energy source. Fluid supply 20 provides a flow of an energizable fluid, for example, gas, to the fluid inlet port of thermal spray gun 12. Depending upon the type of thermal spray process being performed, the fluid flow may be a carrier gas for the coating material, may be a fuel that is ignited to at least partially melt the coating material, or both. While fluid supply 20 may be enclosed in enclosure 11 as shown in FIG. 1A, in other examples, fluid supply 20 may be external to enclosure 11.

In some examples, thermal spray gun 12 may include a material inlet port coupled to material reservoir 18. Material reservoir 18 may be enclosed in enclosure 11, or may be located external to enclosure 11. Coating material may be fed from material reservoir 18 to thermal spray gun 12 in powder form, and may mix with fluid from fluid supply 20 within thermal spray gun 12. In other examples, thermal spray gun 12 may omit material inlet port, and a material feed line may provide coating material from material reservoir 18 at a region outside thermal spray gun 12, for example, near a nozzle or outlet of thermal spray gun 12. The composition of the coating material may be based upon the composition of the coating to be deposited on substrate 12, and may include, for example, a metal, an alloy, a ceramic, or the like.

Thermal spray system 10 also includes an energy source, which may be included in thermal spray gun 12 or may be separate from thermal spray gun 12. The energy source provides energy to at least partially melt (e.g., partially melt or substantially fully melt) the coating material provided through the material inlet port. In some examples, the energy source includes a plasma electrode, which may energize fluid provided through a fluid supply line to form a plasma. In other examples, the energy source includes an electrode that ignites gas provided through the fluid supply line 20.

As shown in FIG. 1A, thermal spray 17 exits the outlet of thermal spray gun 12. In some examples, the outlet includes a spray gun nozzle. Thermal spray 17 may include at least partially melted coating material carried by a carrier fluid. Thermal spray gun 12 may be configured and positioned to direct the at least partially melted coating material at substrate 14 to eventually form coating 16.

While enclosure 11 completely surrounds thermal spray gun 12 and substrate 14 in example system 10 shown in FIG. 1A, in other examples, enclosure 11 may only partially surround one or both of thermal spray gun 12 or substrate 14, or may not be included in system 10.

In some examples, system 10 may include a spray controller 22. Spray controller 22 may include circuitry for controlling the operation, orientation, or location of one or more of thermal spray gun 12, substrate 14, material reservoir 18, or fluid supply 20. For example, spray controller 22 may send control signals to one or more of thermal spray gun 12, substrate 14, or material reservoir 18, or to an industrial robot, platform, a movable multi-axis stage, or one or more suitable mechanisms for holding one or more of thermal spray gun 12, substrate 14, material reservoir 18, or fluid supply 20 in respective locations and orientations. In some examples, computing device 30 may send control signals to spray controller 22 for ultimately controlling the operation of system 10. In other, examples, system 10 may not include spray controller 22, and computing device 30 may act as a spray controller by sending respective control signals to other components of system 10.

Computing device 30 may thus ultimately control the operation of thermal spray gun 12 to apply coating 16 to substrate 14. In some examples, computing device 30 may control thermal spray gun 12 to thermally spray substrate 14 in a thermal spray cycle. An example of a thermal spray cycle is shown in FIG. 1B.

FIG. 1B is a conceptual and schematic diagram illustrating an example thermal spray cycle of coating 16 applied to substrate 14 by thermal spray system 10 of FIG. 1A. As shown in FIG. 1B, the thermal spray cycle may include a plurality of passes 19 of a spraying cycle of the coating material sprayed from thermal spray gun 12 to form coating 16. For example, computing device 30 may control thermal spray gun 12 to apply plurality of passes 19 on substrate 14. In some examples, plurality of passes 19 may include an alternating plurality of passes. In some examples, a single thermal spray cycle may include forming one layer of coating 16, for example, including plurality of passes 19 that substantially cover an underlying layer, for example, a major surface of substrate 14, or a previous layer of coating 16. A single pass of the plurality of passes may include a single traversal or substantially linear sweep along substrate 14 from a beginning of a pass path to an end of a pass path (e.g., from one edge of substrate 14 to another edge of substrate 14). While alternating passes are shown in FIG. 1B, thermal spray gun 12 apply coating 16 using any suitable combination of passes, for example, staggered, undulating, crisscross, zigzag, spiral, curved, parallel, or unidirectional passes. In some examples, at least some passes of plurality of passes 19 overlap.

A single thermal spray cycle may thus be initiated at time t₁, for example, near one corner of substrate 14, and terminated at time t₂, for example, at the diagonally opposite corner of substrate 14. In other examples, thermal spray cycle may be initiated and terminated at any other suitable locations along substrate 14. The mid-point of the thermal spray cycle may be determined by the approximate location of the plume of thermal spray 17 along substrate 14 at time (t₁+t₂)/2. In some examples, the location of the plume at the mid-point may be substantially at or near a geometric mid-point of coating 16 on substrate 14.

Computing device 30 may thus control thermal spray gun 12 to execute at least one thermal spray cycle, thus applying at least one layer of coating material that eventually forms completed coating 16 on substrate 14.

Thermal spray 17 may exert a thrust force and heat on substrate 12. Thus, as thermal spray gun 12 sprays the plurality of passes on substrate 12, one or both of substrate 12 and coating 16 may be subjected to bending deflections and temperature fluctuations or changes. System 10 may include components for detecting such bending deflections and temperature changes. For example, system 10 may include one or more of a respective strain gauge 24, or a respective laser sensor 26a (26b, 26c) adjacent or at each respective predetermined location of the at least one predetermined location to detect the deflection of substrate 14. For example, respective strain gauge 24 may be adjacent to or in contact with substrate 14 at or adjacent each respective predetermined location of the at least one predetermined location. Strain gauge 24 may be configured to generate a signal indicative of a respective deflection of substrate 14 at the respective at least one predetermined location. While system 10 includes a single strain gauge 24 in the example shown in FIG. 1A, in other examples, system 10 may include two, three, or more strain gauges.

Laser sensor 26a (26b, 26c) may be at or adjacent each respective predetermined location of the at least one predetermined location along substrate 14. In some examples, system 10 includes at least three respective laser sensors 26a, 26b, and 26c, respectively adjacent at least three respective predetermined locations along substrate 14. While system 10 includes three laser sensors 26a, 26b, and 26c in the example shown in FIG. 1A, in other examples, system 10 may include one, two, four, or more laser sensors. Laser sensor 26a may be configured to generate a signal indicative of a respective deflection of substrate 14 at the respective at least one predetermined location. Computing device 30 may be configured to determine the bending deflection of substrate 14 after receiving, from laser sensor 26a (26b, 26c), the signal indicative of the respective deflection.

The at least one location of respective strain gauge 24 or respective laser sensor 26a (26b, 26c) may include any suitable location along substrate 14. In some examples, the at least one location may include a location at or near substantially a center of substrate 14, or at or adjacent ends of substrate 14. In some examples, respective strain gauge 24 may be adjacent or at one or more predetermined location of the at least one predetermined locations, while respective laser sensor 26a (or other laser sensors) may be adjacent or at other of the predetermined locations of the at least one predetermined location.

System 10 may include at least one thermocouple 27 to detect a temperature of substrate 14, at least one pyrometer 28 to detect a temperature of coating 16, or both. In some examples, system 10 may alternatively or additionally include infrared temperature sensors to detect the respective temperature of substrate 14, coating 16, or both. Computing device 30 may receive signals from one or more of respective strain gauge 24, respective laser sensor 26a (or 26b, or 26c), at least one thermocouple 27, or at least one pyrometer 28 indicative, respectively, of deflection or temperature of substrate 14 or coating 16, and may analyze the signal to determine the respective temperature or deflection. As described elsewhere in the disclosure, computing device 30 may determine a curvature of substrate 14 from the deflection. Computing device 30 may thus monitor the temperature and curvature of one or both of substrate 14 or coating 16 at predetermined intervals during thermal spray pass 19, or during a thermal spray cycle including a plurality of passes 19, or during a thermal spray process including a series of thermal spray cycles.

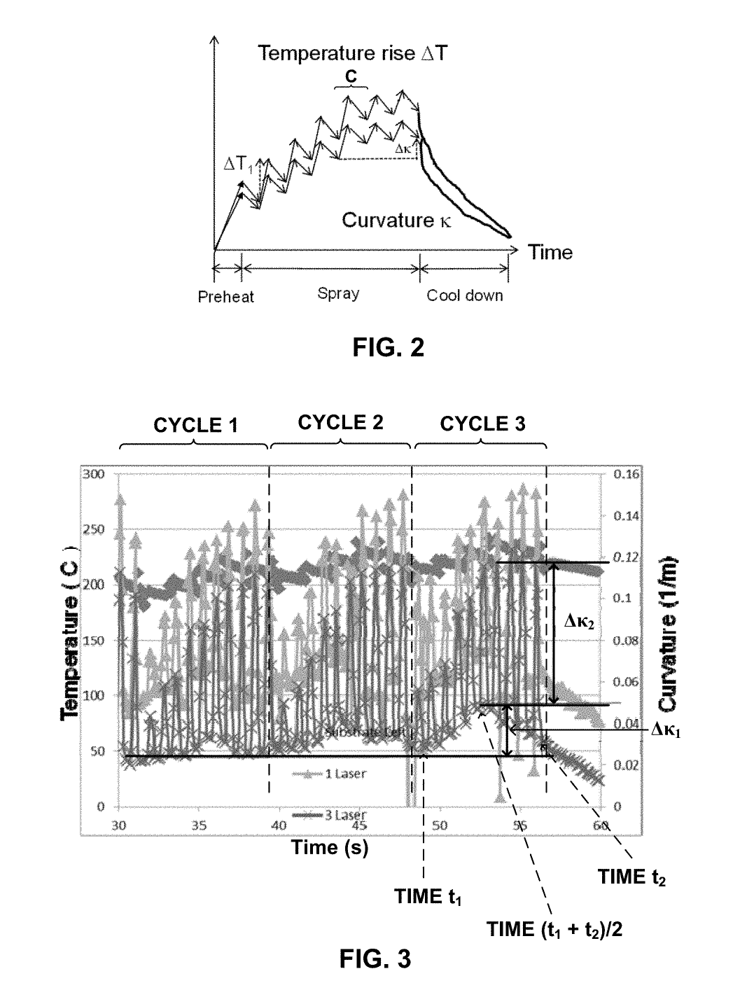

FIG. 2 is a schematic chart illustrating temperature of substrate 14 as a function of time for multiple thermal spray cycles during an example thermal spray process. As shown in FIG. 2, substrate 14 may be preheated to a first temperature before commencing spraying substrate 14 with a series of thermal spray cycles (one thermal cycle of which is labelled C). During one thermal spray cycle C, the temperature (upper curve) and the curvature (lower curve) of substrate 14 may change. For example, both the temperature and curvature of substrate 14 may rise to peak at approximately the mid-point of cycle C, and then reduce towards the end of cycle C, before rising again during a subsequent cycle. As shown in FIG. 2, after the thermal spraying is completed to apply a series of layers of coating material forming coating 16, substrate 12 eventually cools down, and relaxes to a substantially undeflected (or uncurved) configuration from the deflected or curved configurations assumed during thermal spraying.

While FIG. 2 illustrates a single peak for each thermal spray cycle, substrate 14 and coating 16 may be exhibit further sub-changes in temperature and deflection or curvature during thermal spray pass 19 of the plurality of passes within a single thermal cycle C, as shown in FIG. 3.

FIG. 3 is a schematic chart illustrating thermal spray passes and cycles during an example thermal spray process. As shown in FIG. 3, each thermal spray cycle (cycle 1, cycle 2, and cycle 3), includes sub-fluctuations in temperature (diamonds), and curvature, as detected using single laser sensor 26a (triangles) and using three laser sensors 26a, 26b, and 26c (x's). Thus, both temperature and curvature may rise within a single pass to a respective peak, and then lower to a respective minimum, before rising again in a subsequent pass.

Computing device 30 may determine these fluctuations of temperature and curvature, and based on such fluctuations, eventually determine properties of coating 16, for example, residual stress or modulus of coating 16. Based on the properties of coating 16, for example, one layer of coating 16 or of coating 16 as a whole, computing device 30 may determine thermal spray parameters to be used for controlling thermal spray gun 12 to generate coating 16 having properties meeting predetermined specifications.

Returning to FIG. 1A, computing device 30 may include non-volatile storage for storing instructions and data and may include a processor 31 for executing the instructions. In some examples, the non-volatile storage of computing device 30 may include one or more modules including one or both of instructions and data. For example, computing device 30 may include one or more of curvature detection module 32, coating analysis module 34, finite element analysis module 36, fast Fourier transform (FFT) module 38, or spray control module 39. Curvature detection module 32 may receive signals from respective strain gauge 24 or respective laser sensor 26a (26b, 26c) and may determine a bending deflection of substrate 14 at at least one predetermined location based on the signal. Curvature detection module 32 may further calculate a curvature of substrate 14 based on the deflection. For example, by comparing the deflection at at least one predetermined location during a particular time interval during spraying with an initial deflection at the same at least one predetermined location before the spraying, curvature detection module 32 may determine the curvature of substrate 14. Coating analysis module 34 may determine properties of the coating, for example, residual stress, modulus, or other properties, based on the curvature. For example, coating analysis module 34 may use a thin film equation or a thick film equation described elsewhere in the disclosure to determine residual stress based on the curvature.

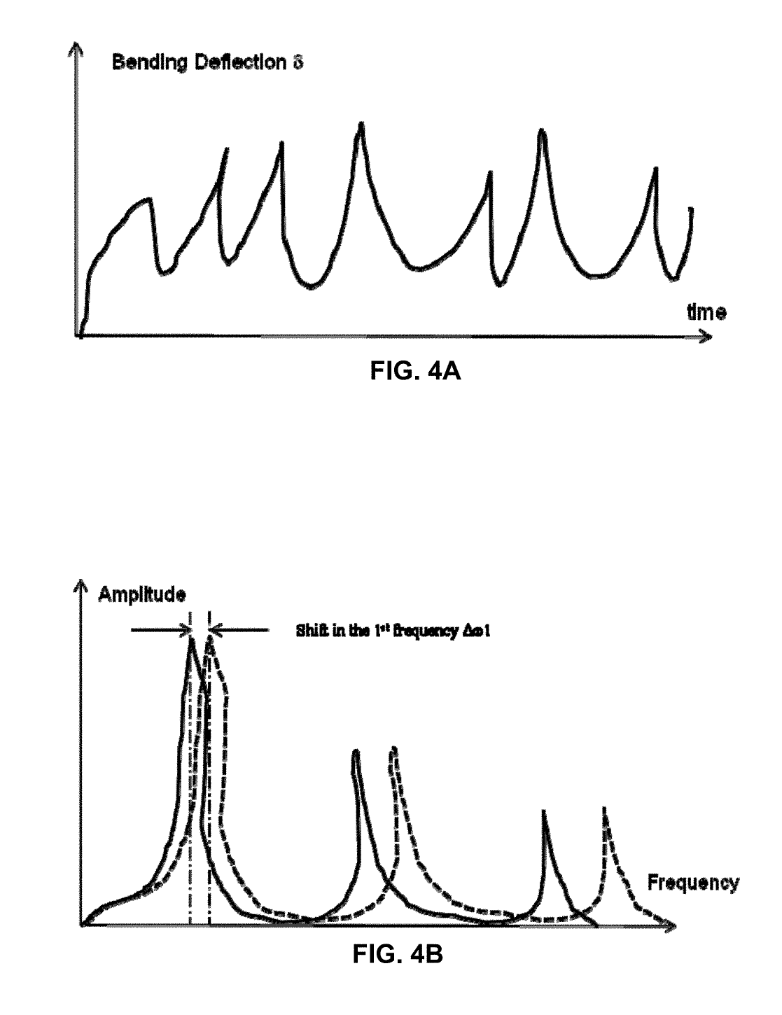

In some examples, coating analysis module 34 may analyze peak shifts in frequency spectra of bending deflections of substrate 14. In some such examples, FFT module 38 may analyze variations in bending deflections of substrate 14 over predetermined windows of time to determine a frequency spectrum of bending deflection over that window, as described with reference to FIGS. 4A and 4B.

FIG. 4A is a schematic chart illustrating temporal changes in bending deflection of substrate 14 during a thermal spray process. FIG. 4B is a schematic chart illustrating peak shifts in frequency spectra of bending deflections during the thermal spray process. Finite element analysis module 36 may store a digital representation of a finite element model (FEM) of substrate 14 and coating 16. Finite element analysis module 36 may simulate the response of substrate 14 to thermal spraying by iterating the FEM of substrate 14 based on predetermined constraints or boundary conditions and subjected to a model simulating the thermal spraying of the substrate. Finite element analysis module 36 may determine shifts in one or more frequency peaks for the FEM for conditions simulating those of the thermal spraying process, based on a test modulus of the coating. Coating analysis module 34 may change the test modulus and compare the shifts in frequency peaks for the FEM for different test moduli with shifts in frequency peaks for substrate 14, until the shifts in the frequency peaks substantially match. For example, finite element analysis module 36 may determine a value of an objective function based on differences between predicted plurality of shifts and corresponding observed plurality of shifts. Finite element analysis module 36 may determine the test modulus associated with the predicted plurality of shifts of the FEM such that the objective function satisfied a predetermined condition.

Based on the properties of coating 16 determined by computing device 30, for example, one or both of residual stress or modulus of coating 16, computing device 30 may control a spray process to produce a subsequent coating having properties within predetermined specifications. The predetermined specifications may include a coating thickness, a coating modulus (for example, a Young's modulus), a residual stress in coating 16, or a coating hardness. The subsequent coating may be a subsequent layer of coating 16, or a coating similar to coating 16 applied to a second substrate, or a coating similar to coating 16 re-applied to substrate 14 after scrubbing or cleaning a previous coating from substrate 14. For example, spray control module 39 may generate one or more control signals based on one or both of modulus or residual stress determined for coating and based on acceptable ranges of modulus, residual strength, or other predetermined properties of coating 16. The control signals may be sent to and received by spray controller 22 to control the operation of thermal spray gun. While different modules of computing device 30 have been described, example techniques according to the disclosure are described with reference to computing device 30. An appropriate module of computing device 30 may perform one or more steps of example techniques according to the disclosure. In some examples, computing device 30 may not include one or more of such modules, and may instead executing instructions corresponding to operations performed by one or more modules.

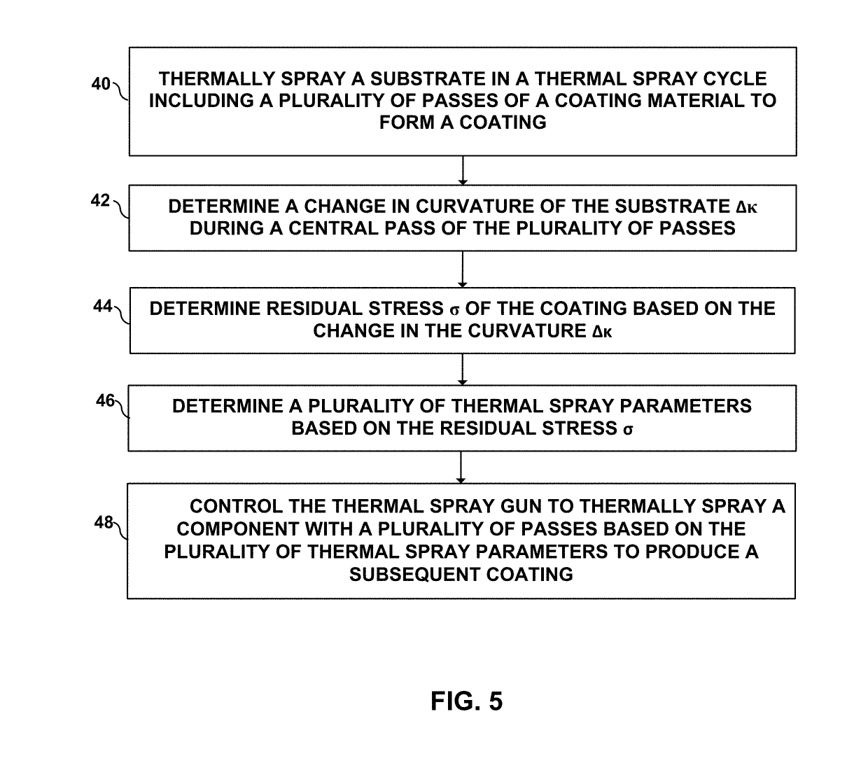

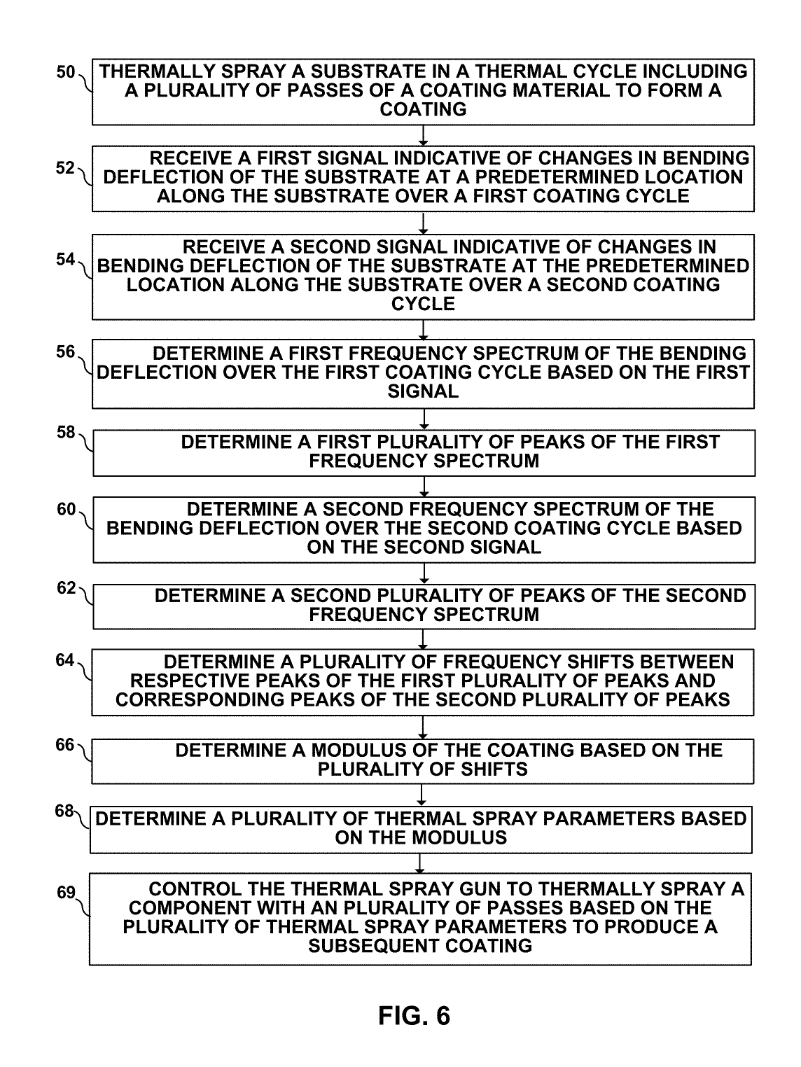

Thus, system 10 may be used for controlling thermal spraying of substrate 14 with coating material from thermal spray gun 12 to form coating 16 having predetermined properties. In addition to example systems for thermal spraying, the disclosure also describes example techniques for thermal spraying, for example, as described with reference to FIGS. 5 and 6.

FIG. 5 is a flow diagram illustrating an example technique for thermal spraying. The example technique of FIG. 5 is described with reference to example system 10 of FIGS. 1A and 1B, and the charts of FIGS. 2 and 3, for convenience and conciseness. However, example techniques according to the disclosure may be implemented using any suitable system.

In some examples, the example technique of FIG. 5 includes, thermally spraying substrate 14 in a thermal spray cycle including a plurality of passes of a coating material to form at least one layer of coating 16 (40). For example, computing device 30 (e.g., spray control module 39) may cause spray controller 22 to control material reservoir 18, fluid supply 20, and thermal spray gun 12 to coat substrate 14 using a plurality of passes of a coating material to form coating 16 (40). The plurality of passes may include plurality of passes 19, as shown in FIG. 1B, or any other suitable plurality of passes of a coating material to form at least one layer of coating 16.

In some examples, the example technique of FIG. 5 includes, determining, by computing device 30 (e.g., by curvature detection module 32), a change in curvature, Δκ, of substrate 14 during a central pass of the plurality of passes (42). In some examples, the central pass is a respective pass of the plurality of passes that includes the mid-point in time of the spraying cycle, for example, mid-point (t₁+t₂)/2, as shown in FIG. 1B. Thus, the change in curvature may be the difference in minimum curvature and maximum curvature during the central pass, for example, Δκ₂, as shown in FIG. 3. The change in curvature at the central pass may be larger than changes in curvature during other time intervals of the thermal spray cycle, and may thus result in one or more of better precision or accuracy in determination of properties, such as residual stress, of coating 16 based on the change in curvature.

In some examples, determining the change in curvature of substrate 14 (42) includes determining, by computing device 30 (e.g., by curvature detection module 32), a bending deflection of substrate 14 at at least one predetermined location along substrate 14. In some examples, the changes in bending deflection of the substrate include vibrations of substrate 14 in response to one or both of forces exerted on substrate 14 by the thermal spraying, for example, by thermal spray 17, or by cooling of coating 16. In some examples, the at least one predetermined location includes at least three locations. In some examples, determining the bending deflection includes receiving, by computing device 30, from respective laser sensor 26a (26b, 26c) adjacent each respective predetermined location of the at least one predetermined location, a signal indicative of a respective deflection of substrate 14 at the respective at least one predetermined location.

In some examples, determining the bending deflection includes receiving, by computing device 30 (e.g., by curvature detection module 32), from respective strain gauge 24 in contact with substrate 14 at each respective predetermined location of the at least one predetermined location, a signal indicative of a respective deflection of substrate 14 at the respective at least one predetermined location. Computing device 30 may determine change in curvature of substrate 14 based on the bending deflection. For example, computing device 30 may relate a known relation between deflections and curvature associated with a geometry of substrate 14.

In some examples, the example technique of FIG. 5 includes, determining, by computing device 30 (e.g., by coating analysis module 34), residual stress σ of the coating based on the change in the curvature Δκ (44). For example, computing device 30 may determine the residual stress σ (44) by determining a change in a thickness Δt_{D} of coating 16 during the central pass. Computing device 30 may determine the residual stress σ based on a relationship including Δt_{D} and Δκ. Computing device 30 may receive a signal, for example, from a laser sensor or optical sensor, or any suitable sensor, or from user input, indicative of the change in thickness Δt_{D}. Computing device 30 may then evaluate properties of coating 16 based on Δt_{D} and other factors. For example, computing device 30 (e.g., coating analysis module 34) may determine the residual stress σ (44) by evaluating a thin film equation:

$$σ = \frac{{E}_{s}^{′} {t}_{s}^{2} Δκ}{6 Δ {t}_{D}} . \qquad ( Equation 1 )$$

In EQUATION 1, tₛ is a thickness of substrate 14,

$${E}_{s}^{′} = \frac{{E}_{s}}{1 - {v}_{s}} ,$$

Eₛ is the Young's modulus of substrate 14, and vₛ is the Poisson's ratio of substrate 14. Thus, based on various known properties of substrate 14, change in thickness Δt_{D} of coating 16, and change in curvature Δκ of substrate 14, computing device may determine residual stress σ of coating 16.

In some examples, computing device 30 (e.g., coating analysis module 34) may determine the residual stress σ (44) by evaluation a thick film equation, for example, when a thickness of coating 16 is greater than a predetermined threshold:

$$σ = \frac{{E}_{s}^{′} {t}_{s} ( {t}_{s} + {β}^{5 / 4} Δ {t}_{D} ) Δκ}{6 Δ {t}_{D}} \qquad ( Equation 2 )$$

In EQUATION 2, tₛ is a thickness of substrate 14,

$$β = \frac{{E}_{D}^{′}}{{E}_{s}^{′}} , {E}_{s}^{′} = \frac{{E}_{s}}{1 - {v}_{s}} ,$$

Eₛ is the Young's modulus of substrate 14, vₛ is the Poisson's ratio of substrate 14,

$${E}_{D}^{′} = \frac{{E}_{D}}{1 - {v}_{D}} ,$$

is the Young's modulus of coating 16, and v_{D} is the Poisson's ratio of coating 16.

Computing device 30 (e.g., coating analysis module 34) may select between EQUATION 1 and EQUATION 2 based on an average thickness of coating 16. For example, if the average thickness of coating 16 is less than a predetermined threshold, computing device may select and apply EQUATION 1 (thin film equation), while if the average thickness is greater than or equal to the predetermined threshold, computing device 30 may select and apply EQUATION 2 (thick film equation).

Thus, computing device 30 (e.g., coating analysis module 34) may determine residual stress σ of coating 16. Computing device 30 (e.g., spray control module 39) may control a subsequent thermal spray process based on the residual stress of coating 16.

For example, the example technique of FIG. 5 may further include determining, by computing device 30 (e.g., by spray control module 39), a plurality of thermal spray parameters based on the residual stress σ (46). The thermal spray parameters are configured to produce a second coating with residual stress within a predetermined acceptable range. For example, the example technique may include forming a plurality of test coatings, and determining respective residual stresses for each respective test coating of the plurality of test coatings. Computing device 30 may associate the respective residual stresses with respective thermal spray parameters that produced the respective coating. Computing device 30 may create calibration curves or determined thresholds for one or more thermal spray parameters based on parameter values associated with acceptable residual stresses, and determine thermal spray parameters for a subsequent thermal spray cycle or process. Thus, the subsequent thermal spray cycle or process may form a coating having an acceptable residual stress, for example, residual stress lower than a predetermined threshold. The second coating may be a different coating on component. For example, the component may include substrate 14, or a different substrate. In some examples, the second coating may be a subsequent layer of or a coating applied on coating 16.

In some examples, the example technique of FIG. 5 further includes thermally spraying substrate 14 with a plurality of passes based on the plurality of thermal spray parameters to produce the second coating (48). For example, computing device 30 (e.g., spray control module 39) may control the thermal spraying, for example, by sending control signals to spray controller 22 based on one or more of the residual stress or other properties of coating 16 (or an intermediate layer of coating 16), to eventually form coating 16 or a subsequent coating having properties substantially meeting predetermined coating specifications on a component, for example, a component including substrate 14 or a different substrate.

While computing device 30 may determine residual stress based on curvature using known relationships between curvature and residual stress, as described with reference to the example technique of FIG. 5, in other examples, computing device 30 may determine other properties of coating 16 without relying on such relationships between properties.

FIG. 6 is a flow diagram illustrating an example technique for thermal spraying. The example technique of FIG. 6 is described with reference to example system 10 of FIGS. 1A and 1B, and the curves of FIGS. 2 and 3, for convenience and conciseness. However, example techniques according to the disclosure may be implemented using any suitable system.

In some examples, the example technique of FIG. 6 includes thermally spraying substrate 14 in a thermal cycle including a plurality of passes of a coating material to form coating 16 (50). For example, computing device 30 (e.g., spray control module 39) may cause spray controller 22 to control material reservoir 18, fluid supply 20, and thermal spray gun 12 to coat substrate 14 using a plurality of passes of a coating material to form coating 16 (50).

In some examples, the technique of FIG. 6 includes receiving, by computing device 30 (e.g., by curvature detection module 32), a first signal indicative of changes in bending deflection of substrate 14 at a predetermined location along the substrate over a first coating cycle (52). In some examples, the at least one predetermined location comprises at least three locations. In some examples, the example technique includes receiving, by computing device 30, a second signal indicative of changes in bending deflection of substrate 14 at the predetermined location along substrate 14 over a second coating cycle (54). In some examples, the changes in bending deflection of the substrate include vibrations of substrate 14 in response to force exerted on substrate 14 by the thermal spraying, for example, by thermal spray 17. In some examples, receiving one or both of the first signal or the second signal (52 or 54) includes receiving, by computing device 30 (e.g., by curvature detection module 32), from respective gauge 24 in contact with substrate 14 at each respective predetermined location of the at least one predetermined location, one or both of the first signal or the second signal. In some examples, one or both of receiving the first signal or the second signal (52 or 54) includes receiving, by computing device 30, from respective laser sensor 26a (26b, 26c) one or both of the first signal or the second signal.

Computing device 30 (e.g., coating analysis module 34) may determine properties of coating 16 based on the bending deflections. For example, computing device 30 (e.g., fast Fourier transform module 38) may perform a fast Fourier transform (FFT) on a time-domain representation of bending deflections to obtain a frequency-domain representation, for example, a frequency spectrum. Computing device 30 (e.g., coating analysis module 34) may compare the frequency spectra at different time intervals to determine properties of coating 16. For example, the example technique of FIG. 6 may include, determining, by computing device 30, a first frequency spectrum of the bending deflection over the first coating cycle based on the first signal (56). Computing device 30 may determine a second frequency spectrum of the bending deflection over the second coating cycle based on the second signal (60). In some examples, computing device 30 may determine the first frequency spectrum (56) the second frequency spectrum (60) by respectively performing fast Fourier transform (FFT) on the first signal and on the second signal. Computing device may compare the first frequency spectrum and the second frequency spectrum to determine properties of coating 16. For example, computing device 30 (e.g., coating analysis module 34) may determine a first plurality of peaks of the first frequency spectrum (58), and determine a second plurality of peaks of the second frequency spectrum (62). In some examples, computing device 30 may determine a plurality of frequency shifts between respective peaks of the first plurality of peaks and corresponding peaks of the second plurality of peaks (64), for example, to compare the first and second spectra.

Based on the comparison, computing device 30 (e.g., coating analysis module 34) may determine a property of coating 16, for example, a modulus of coating 16. For example, computing device 30 may determine a modulus of coating 16 based on the plurality of shifts (66). In some examples, computing device 30 (e.g., finite element analysis module 36) may determine the modulus of coating 14 based on the plurality of shifts by iterating a finite element model (FEM) of substrate 14 subjected to a model simulating the thermal spraying of substrate 14, assigning a test modulus to the FEM, determining a predicted plurality of shifts based on the FEM and on the test modulus, comparing the predicted plurality of shifts of the FEM to the observed plurality of shifts by varying the test modulus, determining a value of an objective function based on the differences between the predicted plurality of shifts and corresponding observed plurality of shifts, and determining the modulus to be the test modulus associated with the predicted plurality of shifts of the FEM such that the objective function satisfies a predetermined criterion. The objective function is a variable to be minimized, for example, a difference between actual and observed plurality of shifts. The predetermined criterion may include a threshold value, a threshold value of a derivative of the objective function, or a second derivative of the objective function, or any suitable criterion indicative of a local or a global minimum of the objective function. In some examples, the model incorporates a predetermined test force exerted on the FEM by the thermal spraying. For example, the test force may be substantially similar to or include one or both of a thrust force exerted by thermal spray 17 from thermal spray gun 12 on substrate 14, or cooling force resulting from cooling of coating 16.

In some examples, the example technique of FIG. 6 further includes determining, by computing device 30 (e.g., by coating analysis module 34), a plurality of thermal spray parameters based on the modulus (68). The thermal spray parameters may be configured to produce a second coating with modulus within a predetermined acceptable range. For example, the example technique may include forming a plurality of test coatings, and determining respective moduli for each respective test coating of the plurality of test coatings. Computing device 30 may associate the respective moduli with respective thermal spray parameters that produced the respective coating. Computing device 30 may create calibration curves or determined thresholds for one or more thermal spray parameters based on parameter values associated with acceptable moduli, and determine thermal spray parameters for a subsequent thermal spray cycle or process. Thus, the subsequent thermal spray cycle or process may form a coating having an acceptable modulus, for example, modulus within a predetermined range. The second coating may be a different coating on a component. For example, the component may include substrate 14, or a different substrate. In some examples, the second coating may be a subsequent layer of or a coating applied on coating 16.

In some examples, the example technique of FIG. 6 further includes thermally spraying substrate 14 with a plurality of passes based on the plurality of thermal spray parameters to produce the second coating (69). For example, spray control module 39 may send one or more control signals to spray controller 22 to control thermal spray gun to produce the second coating (69). For example, computing device 30 (e.g., spray control module 39) may control the thermal spraying, for example, by sending control signals to spray controller 22 based on one or more of the moduli or other properties of coating 16 (or an intermediate layer of coating 16), to eventually form coating 16 or a subsequent coating having properties substantially meeting predetermined coating specifications on a component, for example, a component including substrate 14 or a different substrate.

Thus, systems and techniques described above may be used to control thermal spray of substrates with coatings having properties satisfying predetermined specifications.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in a computer system-readable medium, such as a computer system-readable storage medium, containing instructions. Instructions embedded or encoded in a computer system-readable medium, including a computer system-readable storage medium, may cause one or more programmable processors, or other processors, to implement one or more of the techniques described herein, such as when instructions included or encoded in the computer system-readable medium are executed by the one or more processors. Computer system readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer system readable media. In some examples, an article of manufacture may comprise one or more computer system-readable storage media.

Various examples have been described. These and other examples are within the scope of the following claims.

1. A method comprising:
thermally spraying a substrate in a thermal spray cycle comprising a plurality of passes of a coating material to form a coating;
determining, by a computing device, a change in curvature of the substrate Δκ during a central pass of the plurality of passes; and
determining, by the computing device, residual stress σ of the coating based on the change in the curvature Δκ.

2. The method of claim 1, wherein determining the residual stress σ comprises determining, by the computing device, a change in a thickness Δt_{D} of the coating during the central pass and determining the residual stress σ based on a relationship including Δt_{D} and Δκ.

3. The method of claim 2, wherein determining the residual stress σ comprises evaluating, by the computing device, a thin film equation
$$σ = \frac{{E}_{s}^{′} {t}_{s}^{2} Δκ}{6 Δ {t}_{D}} ,$$
where tₛ is a thickness of the substrate, wherein
$${E}_{s}^{′} = \frac{{E}_{s}}{1 - {v}_{s}} ,$$
wherein Eₛ is the Young's modulus of the substrate, and wherein vₛ is the Poisson's ratio of the substrate.

4. The method of claim 2, wherein determining the residual stress σ comprises evaluating, by the computing device, a thick film equation
$$σ = \frac{{E}_{s}^{′} {t}_{s} ( {t}_{s} + {β}^{5 / 4} Δ {t}_{D} ) Δκ}{6 Δ {t}_{D}} ,$$
where tₛ is a thickness of the substrate, wherein
$$β = \frac{{E}_{D}^{′}}{{E}_{s}^{′}}$$
wherein
$${E}_{s}^{′} = \frac{{E}_{s}}{1 - {v}_{s}} ,$$
wherein Eₛ is the Young's modulus of the substrate, wherein vₛ is the Poisson's ratio of the substrate, wherein
$${E}_{D}^{′} = \frac{{E}_{D}}{1 - {v}_{D}} ,$$
wherein E_{D} is the Young's modulus of the coating, and wherein v_{D} is the Poisson's ratio of the coating.

5. The method of claim 1, wherein determining the change in curvature of the substrate comprises determining a bending deflection of the substrate at at least one predetermined location along the substrate.

6. The method of claim 5, wherein the at least one predetermined location comprises at least three locations.

7. The method of claim 5, wherein determining the bending deflection comprises receiving, by the computing device, from a respective laser sensor adjacent each respective predetermined location of the at least one predetermined location or from a respective strain gauge in contact with the substrate at each respective predetermined location of the at least one predetermined location, a signal indicative of a respective deflection of the substrate at the respective predetermined location.

8. The method of claim 1, wherein the central pass is a respective pass of the plurality of passes that comprises the mid-point in time of the spraying cycle.

9. The method of claim 1, further comprising:
determining, by the computing device, a plurality of thermal spray parameters based on the residual stress σ, wherein the coating parameters are configured to produce a second coating with residual stress within a predetermined acceptable range; and
thermally spraying a component with a plurality of passes based on the plurality of thermal spray parameters to produce the second coating.

10. A system comprising:
a thermal spray gun; and
a computing device configured to:
control the thermal spray gun to thermally spray a substrate in a thermal spray cycle comprising a plurality of passes of a coating material to form a coating;
determine a change in curvature of the substrate Δκ during a central pass of the plurality of passes, and
determine residual stress σ of the coating based on the change in the curvature Δκ.

11. The system of claim 10, wherein the computing device is configured to determine the residual stress σ by determining a change in a thickness Δt_{D} of the coating during the central pass and determining the residual stress σ based on a relationship including Δt_{D} and Δκ.

12. The system of claim 11, wherein the computing device is configured to determine the residual stress σ by evaluating a thin film equation
$$σ = \frac{{E}_{s}^{′} {t}_{s}^{2} Δκ}{6 Δ {t}_{D}} ,$$
where tₛ is a thickness of the substrate, wherein
$${E}_{s}^{′} = \frac{{E}_{s}}{1 - {v}_{s}} ,$$
wherein Eₛ is the Young's modulus of the substrate, and wherein vₛ is the Poisson's ratio of the substrate.

13. The system of claim 11, wherein the computing device is configured to determine the residual stress σ by evaluating a thick film equation
$$σ = \frac{{E}_{s}^{′} {t}_{s} ( {t}_{s} + {β}^{5 / 4} Δ {t}_{D} ) Δκ}{6 Δ {t}_{D}} ,$$
where tₛ is a thickness of the substrate, wherein
$$β = \frac{{E}_{D}^{′}}{{E}_{s}^{′}}$$
wherein
$${E}_{s}^{′} = \frac{{E}_{s}}{1 - {v}_{s}} ,$$
wherein Eₛ is the Young's modulus of the substrate, wherein vₛ is the Poisson's ratio of the substrate, wherein
$${E}_{D}^{′} = \frac{{E}_{D}}{1 - {v}_{D}} ,$$
wherein E_{D} is the Young's modulus of the coating, and wherein v_{D} is the Poisson's ratio of the coating.

14. The system of claim 10, wherein the computing device is configured to determine the change in curvature of the substrate by determining a bending deflection of the substrate at at least one predetermined location along the substrate.

15. The system of claim 14, further comprising a respective laser sensor adjacent each respective predetermined location of the at least one predetermined location, wherein the respective laser sensor is configured to generate a signal indicative of a respective deflection of the substrate at the respective predetermined location, wherein the computing device is configured to determine the bending deflection by receiving, from the respective laser sensor, the signal indicative of the respective deflection.

16. The system of claim 15, further comprising at least three laser sensors respectively adjacent at least three respective predetermined locations along the substrate.

17. The system of claim 14, further comprising a respective strain gauge in contact with the substrate at each respective predetermined location of the at least one predetermined location, wherein the strain gauge is configured to generate a signal indicative of a respective deflection of the substrate at the respective predetermined location.

18. The system of claim 10, wherein the central pass is a respective pass of the plurality of passes that comprises the mid-point in time of the spraying cycle.

19. The system of claim 10, wherein the computing device is further configured to:
determine a plurality of thermal spray parameters based on the residual stress σ, wherein the coating parameters are configured to produce a second coating with residual stress within a predetermined acceptable range; and
control the thermal spray gun to thermally spraying a component with a plurality of passes based on the plurality of thermal spray parameters to produce the second coating.

20. A computer readable storage medium comprising instructions that, when executed, cause at least one processor to:
control a thermal spray gun to thermally spray a substrate in a thermal spray cycle comprising a plurality of passes of a coating material to form a coating;
determine a change in curvature of the substrate Δκ during a central pass of the plurality of passes, and
determine residual stress σ of the coating based on the change in the curvature Δκ.
